(19) United States
(12) Patent Application Publication
(10) Pub. No.: US 2012/0310914 A1
(43) Pub. Date: Dec. 6, 2012

(54) Unified Crawling, Scraping and Indexing of Web-Pages and Catalog Interface

(75) Inventor: Shaz Khan, Encino, CA (US)

(73) Assignee: NetSol Technologies, Inc.

(21) Appl. No.: 13/485,703

(22) Filed: May 31, 2012

Related U.S. Application Data
(60) Provisional application No. 61/491,857, filed on May 31, 2011.

(51) Int. Cl. G06F 17/30

(52) U.S. Cl. 707/710; 707/E17.108; 707/E17.083

(57) ABSTRACT

The current subject matter relates to a technique for securing the content of one or more websites that crawls, scrapes, and indexes web-pages associated with websites. Once the content is secured, purchase transactions across heterogeneous vendor websites can be initiated in a unified manner. Related apparatus, systems, techniques and articles are also described.

### RELATED APPLICATION

This application claims priority to U.S. Pat. App. Ser. No. 61/491,857, the contents of which are hereby fully incorporated by reference.

### TECHNICAL FIELD

The subject matter described herein relates to crawling, scraping and indexing of web-pages performed by a unified technique.

### BACKGROUND

When a new website for an entity, such as a corporation, is created, multiple requirements exist, such as securing the content of the website. A login, session management, cookies, SSL, internet protocol (IP) address blocking, redirections, JavaScript, frames, and the like can be used to safely secure the content of the website. A separate implementation of some or all of these security techniques can require considerable time and effort.

### SUMMARY

A unified technique for securing the content of one or more websites is presented herein. This unified technique can be termed as “SmartOCI”. SmartOCI can be a generic utility that can crawl, scrape, and index web-pages associated with websites. SmartOCI can be responsible for scraping required data from HTML pages and indexing the required data in a search engine, such as a Solr search engine.

In particular, in one aspect, a plurality of heterogeneous vendor catalog web pages are crawled to download corresponding files characterizing the web pages. Each catalog web page lists at least one product or service offered for sale. Thereafter, data is scraped (i.e., parsed) from at least a portion of the downloaded files to generate a plurality of processed files and corresponding attributes characterizing each processed file. The attributes characterizing each processed file are then indexed to the corresponding downloaded files in an index. Queries can be received in a graphical user-interface which results in the index being polled to identify one or more of the downloaded files that correspond to the search queries. Subsequently, characterizing the identified one or more downloaded files is rendered in the graphical user interface.

The downloaded files can be in Hyper-Text Markup Language (HTML) format. The processed files can be eXtensible Markup Language (XML) format. The processed files can include attributes specified by a catalog data schema. The polling can be performed by a search engine. The scraping can parses one or more attributes from each web pages including, for example, product item identifier, product description, long text, currency, price, unit, image, uniform resource locator (URL), and United Nations Standard Products and Services Code (UNSPSC).

User authentication data (i.e., username, password, payment information, etc.) can be stored for the plurality of vendor catalog web pages in which at least two of the vendor web pages require different authentication data to complete a transaction for the corresponding product or service.

The data responsive to the search queries can concurrently display results corresponding to two or more vendors having different user authentication requirements. With such an arrangement, user-generated input can be via the graphical user interface, selecting a graphical user interface element associated with a first vendor web page. This later results in the first vendor web page being accessed using the first user authentication data to purchase a corresponding product or service. In addition, user-generated input can be received via the graphical user interface that selects a graphical user interface element associated with the second vendor web page. Similarly, the second vendor web page can be accessed using the second user authentication data to purchase a corresponding product or service.

In an interrelated aspect, data characterizing products or services available from a plurality of vendors via respective websites is provided in a unified catalog interface in response to a keyword search query. The respective websites requiring different user authentication information to purchase the corresponding products or services. Thereafter, a selection of a graphical user interface corresponding to one or more of the products or services of each of two or more selected vendor websites is received in the unified catalog interface. The websites corresponding to the selected graphical user interface element are then accessed using stored user authentication information for each selected vendor website so that transactions can be automatically completed to purchase each corresponding product or service from the two or more vendor websites.

Each selected graphical user interface element can cause the corresponding product or service to be placed in a single shopping cart of the unified interface, the single shopping cart allowing for a single checkout for products or services from different vendor websites requiring different user authentication.

Articles of manufacture are also described that comprise computer executable instructions permanently stored on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein.

The subject matter described herein provides many advantages. For example, the current subject matter prevents significant time and effort associated with individually implementing different security techniques to secure content of a web-page. In addition, the current subject matter presents supplier catalog content for procurement organizations in one unified view and allows users to order from a master shopping cart. Users can also store frequently ordered items in the e-commerce search engine.

The details of one or more variations of the subject matter described herein are set forth in the accompanying drawings and the description below. Other features and advantages of the subject matter described herein will be apparent from the description and drawings, and from the claim.

### DESCRIPTION OF DRAWINGS

FIG. 1A is a first process flow diagram for implementing the current subject matter;

FIG. 1B is a second process flow diagram for implementing the current subject matter;

FIG. 2 is a first architecture diagram for implementing the current subject matter; and

FIG. 3 is a second architecture diagram for implementing the current subject matter.

### DETAILED DESCRIPTION

The current subject matter relates to a generic utility for crawling, scraping and indexing of content associated with web-pages. The generic utility can be termed as “SmartOCI”—a trademark of the Applicant. This generic utility can perform crawling, can scrape required data from HyperText Markup Language (HTML) pages, and can index the required data in a search engine, such as a Solr search engine.

The search engine can be an open source enterprise search platform. The search engine can be a standalone enterprise search server with an application programming interface (API) associated with web-services like API. Documents can be put (“indexed”) in a localized data index, which can be accessed by the search engine via extensible markup language (XML) over hypertext transfer protocol (HTTP). The search engine can be queried via HTTP GET request to receive XML and/or HTTP results. The search engine can provide advanced full-text search capability, hit highlighting, faceted search, dynamic clustering, database clustering, and rich document (e.g. Microsoft word file, PDF file, and the like) handling. The search engine can be highly scalable, and can provide distributed search and index replication. Further, the search engine can power the search and navigation features of one of or a combination of large internet websites, such as search websites.

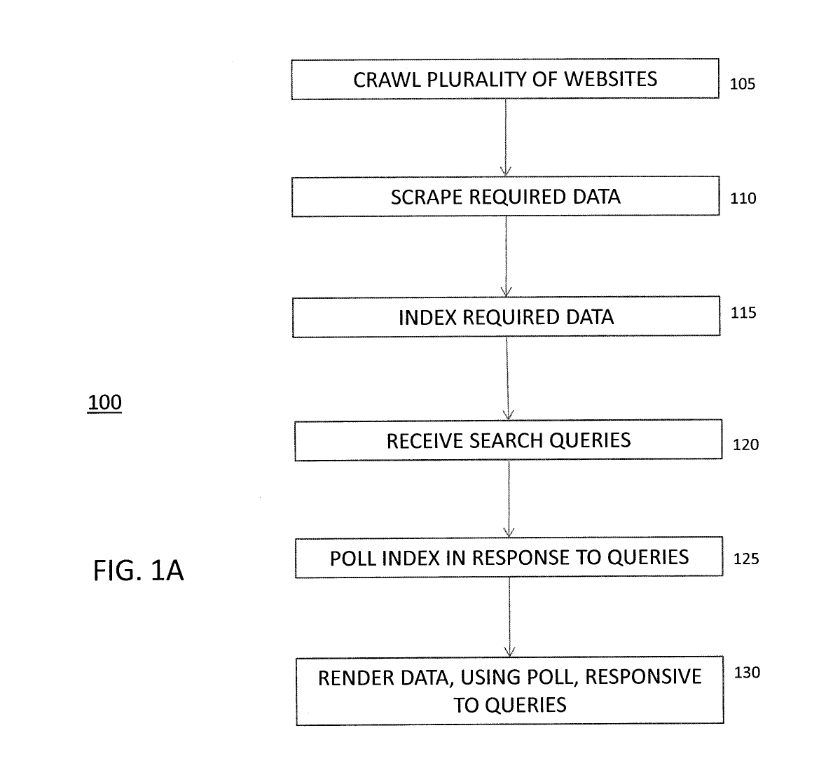

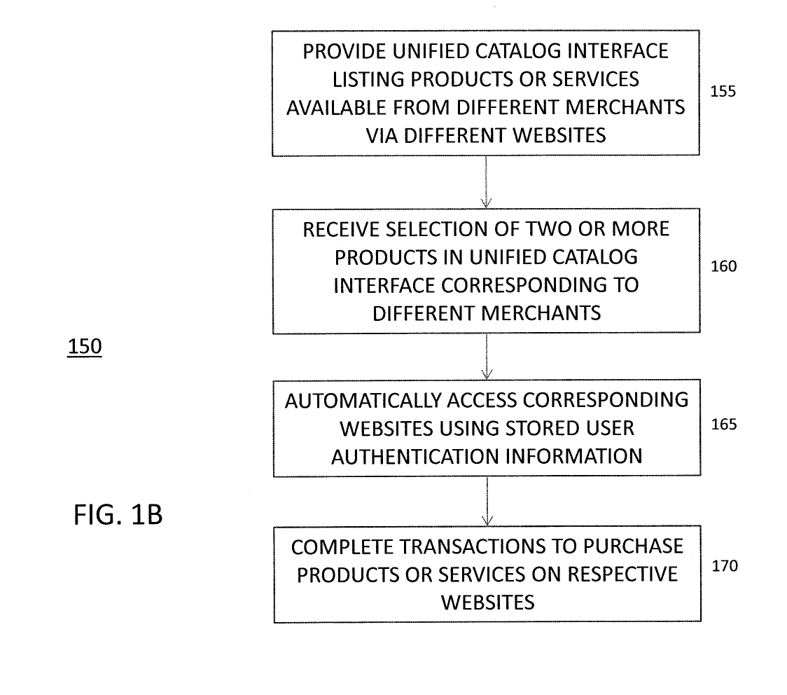

FIG. 1A is a process flow diagram 100 in which, at 105, a plurality of heterogeneous vendor catalog web pages are crawled to download corresponding files characterizing the web pages. Each catalog web page lists at least one product or service offered for sale. Thereafter, at 110, data is scraped (i.e., parsed) from at least a portion of the downloaded files to generate a plurality of processed files and corresponding attributes characterizing each processed file. The attributes characterizing each processed file are then, at 115, indexed to the corresponding downloaded files in an index. Queries can be received, at 120, in a graphical user-interface which results in the index being polled, at 125, to identify one or more of the downloaded files that correspond to the search queries. Subsequently, data characterizing the identified one or more downloaded files is rendered, at 130, in the graphical user interface.

Crawling can be performed by a crawler. The crawling can be web crawling performed by a web crawler. The web crawler can be a computer program that browses World Wide Web over a network, such as intranet or internet, in a methodical and orderly way. Web crawling can also be referred to as spidering. Web crawlers can also be referred to as ants, bots, automatic indexers, web spiders, web robots, web scutters, and the like. In crawling, a crawler can start visiting uniform resource locators (URLs) specified in a list, these URLs being called seeds. As the crawler visits these URLs, the crawler can identify hyperlinks on the webpage associated with a URL being visited. Next, web-pages corresponding to the identified web-pages can be visited.

The behavior of web crawler can include: (i) determining which pages to download, (ii) determining when to check for changes to the web-pages, (iii) determining how to avoid overloading web-pages, and (iv) determining how to co-ordinate with other possible web crawlers. Based on these noted determinations, the corresponding actions can be performed.

Scraping can be performed by a scraper. The scraper can be a computer program. The scraping can be data scraping, which can include one of or a combination of user interface scraping, web scraping, report mining, and the like. Here onwards, web scraping has been discussed with respect to exemplary implementations described below.

Web scraping can be performed to extract information from web-pages. This extracting can be performed by scrapers that simulate manual exploration of web. The simulation can be performed by implementing either hypertext transfer protocol (HTTP) or by embedding browsers, such as internet explorer, mozilla firefox, safari, and the like. While web indexing, as described below, can index web content using a bot, web scraping can be directed to transformation of unstructured web content, typically in HTML format, into structured data that can be stored and analyzed in a central local database or spreadsheet. This transformation can be based on content of an XML file associated with the scraper, wherein the content can include one or more attributes, regular expressions, rules, and the like.

Indexing can be performed by an indexer. The indexer can be a computer program. The indexing can be web indexing. The web indexing can be providing an index, such as an index of a book, for web-pages or intranet. The web indexing can create keyword metadata to provide a more useful vocabulary for internet or corresponding onsite search engines.

FIG. 1B illustrates a process flow diagram 150 in which, at 155, data characterizing products or services available from a plurality of vendors via respective websites is provided in a unified catalog interface in response to a keyword search query. The respective websites requiring different user authentication information to purchase the corresponding products or services. Thereafter, at 160, a selection of a graphical user interface corresponding to one or more of the products or services of each of two or more selected vendor websites is received in the unified catalog interface. The websites corresponding to the selected graphical user interface element are then accessed, at 165, using stored user authentication information for each selected vendor website so that, at 170, transactions can be automatically completed to purchase each corresponding product or service from the two or more vendor websites.

Each selected graphical user interface element can cause the corresponding product or service to be placed in a single shopping cart of the unified interface, the single shopping cart allowing for a single checkout for products or services from different vendor websites requiring different user authentication.

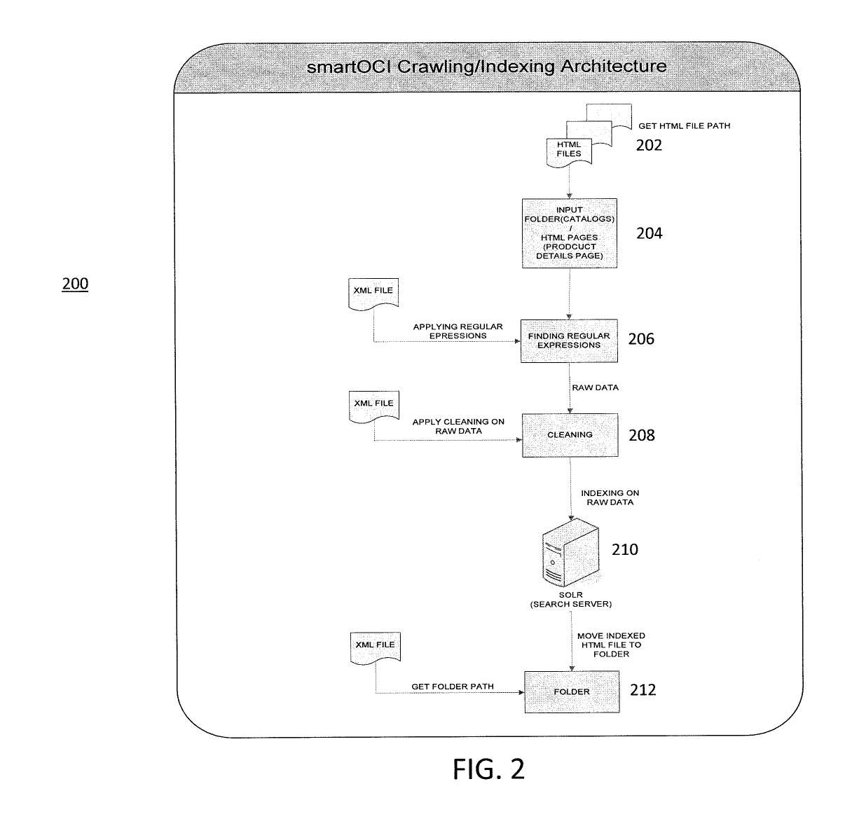

FIG. 2 illustrates an architecture 200 implemented by a method consistent with implementations of the current subject matter.

A downloader can crawl one or more web-pages and download corresponding one or more HTML files. The downloaded one or more HTML files can be stored in a storage device, such as a data disc. The one or more HTML files can be stored in one or more databases. The one or more HTML files can be stored in one or more folders. The steps to configure a downloader to download/obtain items from a web-page corresponding to product details are discussed later in this specification.

At 202, these one or more HTML files can be retrieved by the scraper and by using corresponding one or more file paths. The scraper performs the processing on these retrieved HTML files. These one or more HTML files can be included in one or more folders or databases. At least one of these one or more HTML files can be a product details page.

At 204, the retrieved one or more HTML files can be input to the system and returned back to an organization's corresponding ERP system.

At 206, one or more XML files can be used to find regular expressions. The one or more XML files can be associated with a scraper that performs scraping. These one or more XML files can be accessed before initializing the scraping. The one or more XML files can be read using an application programming interface, such as “Castor API.”

An XML file includes a configuration that can provide the following attributes to the scraper:

(a) Source folder path: The source folder path can be a path to a folder including the one or more HTML files (which can include Product Detail Pages) downloaded by the downloader. This source folder can include sub-folders, which can correspond to external catalogs. External catalogs are e-commerce websites provided and maintained by suppliers which support a roundtrip purchasing transaction.

(b) Target folder path: The target folder path can be the folder where one or more processed HTML files are archived after the crawling, scraping and/or indexing has been performed. This target folder can include sub-folders.

(c) Supplier Name/ID: The supplier name can be a name or an identification of a supplier of a product associated with a Product Detail Page included in the one or more HTML files.

(d) Vendor ID: The Vendor ID can be a name or an identification of a vendor associated with a product associated with a Product Detail Page included in the one or more HTML files.

(e) User ID: The User ID can be a name or identification of a user that initiated the search request against the supplier catalog data.

(f) Catalog ID: The Catalog ID can be a name or identification of a catalog of a specific supplier.

From the XML file, regular expressions or the scraping rules can be accessed, as noted above. These regular expressions or scraping rules can be applied one by one to extract data from the HTML files, as noted below. The scraper can parse contents of the HTML file in a serial approach (one by one approach). The source folder, as noted above, can be input to the scraper to perform the scraping using one or more XML files. Contents of the HTML file can be scraped against regular expressions. Each regular expression can scrape out a required value comprised of a catalog data schema, and can return this value back to the application to save. The catalog data schema can include short description, long description, vendor material number, manufacturer material number, material master number (SAP), vendor quote identifier, vendor name, manufacturer code, material group number, and the like.

At 208, the one or more XML files can be accessed to apply cleaning on the raw data. This data cleaning can be subject to pre-defined rules that can be specified in a XML document. Cleaning can include, but is not limited to, leading space trimming, trailing space trimming, deleting of HTML tags, replacing double quotes or slashes with single quotes or slashes, and the removal of other invalid characters.

This scraped and cleaned data can be saved in a bean, such as a java bean. A bean can be a repository for saving data against corresponding SmartOCI fields which include Short Description, Long Description, Material Group, Unit of Measure, Price, Manufacturer Part Number, Vendor Product Number, and Image.

At 210, this bean can be sent for indexing at Solr search server. The indexing can be performed by an indexer. The indexer can retrieve the data from the bean and can index the retrieved data in the Solr search engine associated with the Solr search server. A user can search a Solr search server using a Solr search engine, such that this indexed data can be searched for viewing or manipulation.

At 212, after scraping and indexing of the HTML file, as discussed above, this HTML file can be moved to another folder. The path of this another folder can be retrieved from the one or more XML files. This retrieval of the path can ensure that this HTML file has finished all of the processes (i.e., crawling, scraping and indexing) required to be performed on this HTML file. Hence, the movement of HTML file to another folder can confirm that the file has finished all of these processes.

Below is further described the crawling process performed by the downloader. Specifically, the following describes configuration of a downloader to download/obtain items from a web-page corresponding to product details.

First, the actual web-page of the supplier catalog product detail page can be browsed, as discussed below. An authentication uniform resource locator (URL) for the web-page can be formed from parameters in a catalog user interface, which can include the catalog URL, a secure username, and a password. The authentication URL can be put in address bar of a browser to access/browse the web-page. The HTML code, redirects, Java scripts (if used), and shortest path to reach a search results page, which correspond to the browsed web-page, can be examined to determine whether a different URL is required for authentication on the web-page. For example, a different URL can be required if a particular web-page uses a plurality of redirects to complete a page submit.

Further, the HTML of the web-page can use frames, wherein on each frame, a JavaScript can be called on body load, when the webpage first gets initiated, to generate the HTML. In this case, the web-page can have no content in the beginning The web-page can call an Asynchronous JavaScript and XML (AJAX) call through JavaScript to fill up the content on the web-page. All such calls can be calculated, using tools such as Tamper Data, and can be configured in the XML file.

Furthermore, each product detail can comprise of two frames. One of these two frames can include an image of the product and long text. The other one of these two frames can include price, currency, unit and United Nations Standard Products and Services Code (UNSPSC). In this case, the HTML file can be examined for the AJAX call being used for the first web-page to obtain the names of the two frames such that these two names can be noted down in the XML configuration file.

Using the steps noted above, the downloader can be configured to download/obtain items from a web-page corresponding to product details.

The following description further describes the scraping and indexing noted above with respect to FIG. 2.

First, a limited set of data and pattern of product details can be examined. Further, both the visible data and the hidden data in an HTML file can be identified. Further, the price, long text, and the like associated with different products on the product details web-page can vary. Accordingly, the following items can be scraped: product item identifier, product description, long text, currency, price, unit, image, URL, UNSPSC, and the like. Next, regular expressions can be created. Further, the indexing routine can be started. Corrections can be made for items that have some information missing.

The architecture of the SmartOCI is described in detail in the following sections: requirements, architecture overview, and functionality points, wherein the functionality points is further described in the following sub-sections: web server, security, front end, user management, internal cache, logger, exception handler, connection pool, converter, CKEditor, and message handling.

Requirements

Table 1 illustrates the requirements associated with the architecture of the SmartOCI.

TABLE 1

| Serial | Software/Tool/ | |
|---|---|---|
| No. | Technology | Purpose |
| 1. | Red Hat Enterprise | Operating System |
| | Linux Server release 6 | |
| 2. | Apache HTTPD | Web Server for smartOCI |
| | Server 2.2.15 | Website |
| 3. | Apache Tomcat 6.0 | Web Server for smartOCI |
| | | Application |
| 4. | Solr 3.1 | Search Engine |
| 5. | Apache Mahout 2.0 | Classification Tool |
| 6. | MySQL 5.1.52 | Database |
| 7. | OpenJDK 1.6.x | JVM for Java |
| 8. | smartOCI Web Site | |
| 9. | smartOCI Application | |
| 10. | smartOCI Crawler, | |
| | web site data and | |
| | Indexer | |
| 11. | SSL Certificate | Security |
| | installation on both | |
| | Apache HTTP and | |
| | Apache Tomcat | |
| | servers | |
| 12. | AJP Connector | Tomcat uses this connector to |
| | Configuration | get requests from Apache |
| | | HTTP server |

Architecture Overview:

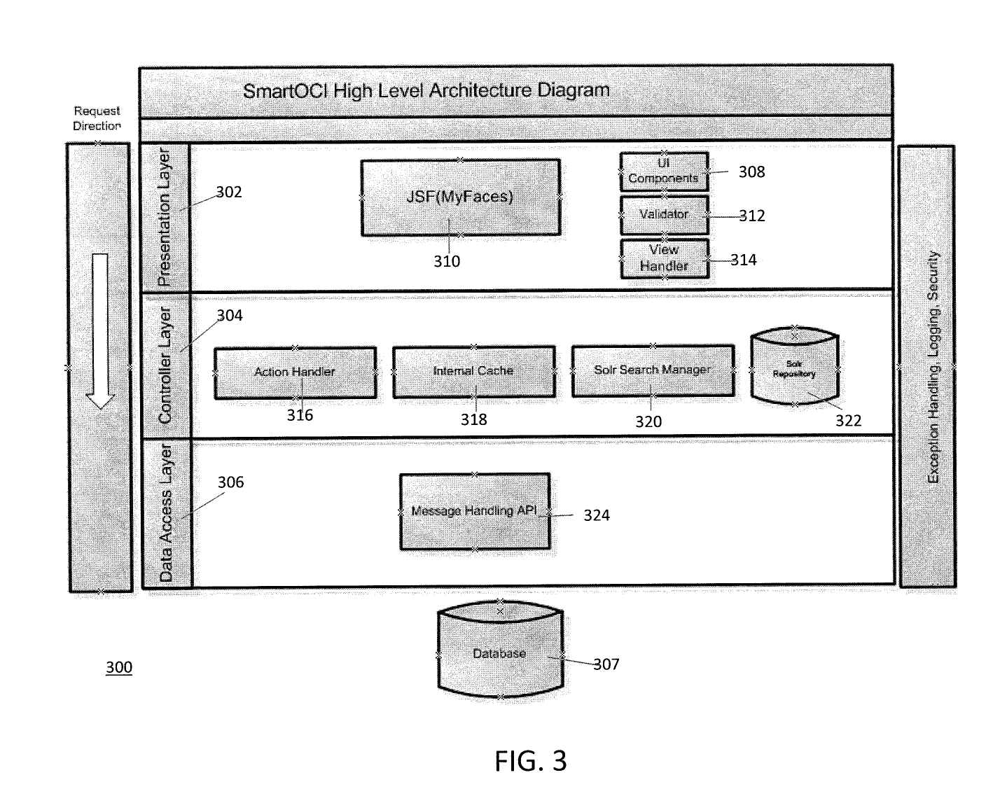

FIG. 3 illustrates an architectural diagram 300 of the SmartOCI in consistency with some implementations of the current subject matter. The architectural diagram 300 can include a presentation layer 302, a controller layer 304, a data access layer 306, and database 307. These layers 302, 304, 306 are described below along with the corresponding modules.

(i) Presentation Layer 302: Presentation layer 302 can represent the front end modules and features that can be used for client-server interaction. Client can interact with the user interface components 308 of presentation layer 302 and elements of such an interaction can get passed on to the next layers 304, 306. The presentation layer 302 can include the following modules:

(a) JSF (MyFaces, RichFaces and Tomahawk) 310: This third party open source UI library can provide basic HTML tags with additional capability of sending AJAX calls. Upon rendering, all of these tags can be converted to standard HTML tags that a browser can understand.

(b) Validator (Scripting) 312: Javascripts can be used as client side scripting. Upon action on a certain screen, the data can be filtered through this component.

(c) View Handler 314: View handler 314 can be a security feature that can be enabled at client side. For example, if an administrator desires disabling some buttons for a certain user, view handler 314 can disable/hide those buttons at client end of the user. Javascripts can be used to perform one of enabling and disabling/hiding of HTML components.

(ii) Controller Layer 304: Controller layer 304 can handle the business logic. Accordingly, controller layer 304 can be referred to as a business logic layer. Controller layer 304 can include an action handler module 316, internal cache 318, solr search manager 320, and a solr search repository 322, which are discussed below:

(a) Action Handler 316: Page controller design pattern can be used here. Thus, each page can have its own controller that processes the client request. Standard JAVA language can be used to develop the action handler 316.

(b) Internal Cache 318: An inbuilt internal cache module 318 can be integrated in the application. Internal cache module 318 can improve the performance of the application. All the static data can be loaded in internal cache 318. In response to request for the static data, the loaded static data can be sent from the internal cache 318. Data that can be cached includes resource files, static drop down values, application configuration files, and the like.

(c) Solr Search Manager 320: Solr Search Manager 320 can handle all the search related stuff associated with the Solr Search Manager 320. Solr Search Manager 320 can receive a search query. In response to this search query, Solr Search Manager 320 can communicate with Solr Repository 322 to fetch the results for the search query.

(iii) Data Access Layer 306: There can be numerous scenarios throughout the application where controller layer 304 can interact with the database 307 either to store data or to fetch data. To minimize this effort and separate this logic associated with storing and/or fetching data from the controller layer, a new component—message handling API 324—can be introduced. The message handling API 324 is discussed below:

(a) Message Handling API 324: The message handling API 324 can provide a standard ORM layer. The controller layer 304 can send the query and its parameters to the message handling API 324. In response, the message handling API 324 can process the request and can generate a valid SQL statement. The message handling API 324 can push the query to the database by getting connection from a pool managed by the application server. The database 307 can send the results back to the data access layer 306. The message handling API 324 can create entity objects and sends those objects back to the controller layer 304. Following can be some types of data that can be returned to a caller:

i. SQL to Entity Objects

ii. SQL to List of Objects

iii. SQL to XML

iv. SQL to String

v. SQL to Drop Down List

vi. Webservice to XML

Functionality points:

This section contains details required out of an individual module of the application. A module can be defined as a separate unit of software or logical arrangement of code. Typical characteristics of modular components can include portability and interoperability. The portability can allow the components to be used in a variety of systems. The interoperability can allow the components to function with components of other systems.

Web Server:

Apache HTTPD Server can be used as a front end server. Apache HTTPD Server can also host the smartOCI web-page.

Apache Tomcat server can be used as a back end server and can also host the smartOCI Application.

AJP connector can be configured for the communication between the Apache HTTPD Server and the Apache Tomcat server.

Security:

SSL certificate can be installed on the server to provide secure communication.

User authentication can be performed from the login user interface.

Front End:

Front End of the application can be attractive and easy to use. The front end can have a rich component support, which includes JSF Core components and Myfaces components that can be used in the development of a modern, highly user-friendly user interface to the application. To provide the AJAX features, aj ax4j sf API can be used.

A user can be provided field level context help. When the user moves the mouse over any tagged control object, such as an image or line of text, the help text can appear. This help text (or help feature) can be integrated with the web-page. Help text for each user interface (UI) can be placed in a separate XML file, so that a non-development related person can modify the text.

Users can be facilitated with cue cards. The purpose of a cue card can be to provide, to users, help regarding a specific user interface. The help regarding the specific user interface can include providing answers for questions, such as “How to use this user interface,” and the like. The cue cards can be available on right pane of the user interface. This right pane may be displayed or can be hidden, based on preference of the user. Each user interface has a separate XML for cue cards. The cue cards can have links to text tutorials, video tutorials, and the like sources of information, as noted below:

Text Tutorials: Cue cards can have link to multiple text tutorials. The text in these tutorials can be included in separate static HTML pages. These pages can provide in depth textual information along with images of how this user interface can be used, what is the expected outcome of the action that the user is performing, and the like.

Video Tutorials: Cue cards can have link to multiple computer based trainings or video demos of the current user interface. These video files, which can be integrated with cue cards, can help user in understanding usage of the user interface.

A user can be provided with a multi-language support, if desired by the user. Thus, multiple user interfaces may not need to be written separately. The user can have a separate file for preferred languages. This separate file can contain labels, captions and messages that can be displayed on the user interface in a particular language.

The user can be provided with lookup user interfaces. Lookup user interfaces can help a user select a value of a field after enabling a search for the desired value. For example, if a user accessing an Employee Registration user interface desires to select a supervisor for a new employee, the supervisor field can have a lookup icon/button against it. When the user clicks/selects the lookup button, a lookup window can appear. The user can search and select supervisor from the lookup user interface and return to the user registration user interface. The supervisor field can be populated by the selected supervisor.

The user can be provided with AJAX support, for field level validations and other user actions where partial submission of information can be required.

User Management:

Application can be supported by a View Handling engine. The View Handling engine can enable easy and dynamic queries that can be performed behind the scenes for user authentication and authorization. User profile can be associated with information about a user or a group of users.

User can configure the type of authorization type in a property file. The type of authorization can be file based or database based, as noted below.

File Based: In file based authentication, one or more users and groups of users are created and specified in an XML file. The application can authenticate login from this XML file.

Database Based: In case of Database based authentication, one or more users can be authenticated by comparison with users specified in a database.

The application can have a capability to apply one or more field level restrictions for the user. The fields, for any user, that can be associated with the one or more field level restrictions can be: disabled, read only, or hidden. These field level restrictions can be placed in an XML configuration file. A user interface can be provided to the administrator to control the user authentication and access restrictions.

Internal Cache:

The application can have an internal cache mechanism that can cache records, thereby allowing a fast processing and minimum database hits. The system can cache the following items:

User configurations: The system can cache user configurations. These user configurations can be retrieved from database or some property files.

User messages: The system can cache user messages saved in the database when the sever starts up. Error messages can be displayed on a user interface. Therefore, through this caching routine, queries may not need to be executed, or values may not need to be hard coded on the user interface to populate user messages.

Error messages: The system can cache the error messages saved in the database at the sever start-up. The caching of the error messages can indicate that the one or more error messages on the user interface system may not have to execute a select statement, and may not have to hard code the value on the user interface.

The system can be capable to cache the SQL query results for a defined number of minutes. For example, there may not be a need to load values from table used to populate the list of countries on the user interface.

Logger:

For logging, Log4J API can be used. Application can be used to perform logging at three levels, viz. Trace, Info, and Debug, which can help monitor the application flow in case of one or more errors. For auditing purpose, each relation in the database can have two additional fields, such as “created on” and “created by.” The purpose of these fields can be to monitor user activities.

Exception Handler:

The application can have a component for exception handling. This component can be inherited from the Exception class. This component can have a functionality to fetch an error detailed message from the database when an exception arises (when an exception is thrown). In the application, the data access layer, where the data can be processed, and the presentation layer, where the user interface can be generated, can throw the exception back to the calling class. In the controller layer, all the exceptions can be handled to make the application consistent.

Connection Pool:

Connection pooling mechanism of Apache Tomcat can be used to manage database connections.

Convertor:

Convertor can be used in the application to convert the objects to XML and convert XML to said objects. These objects can include Microsoft Excel (XLS, XLSX), CSV, TXT, PDF, Microsoft Word (DOC, DOCX), DAT, and the like.

CKEditor:

CKEditor is a text editor that can be used inside web-pages. The CKEditor can be a what you see is what you get (WYSIWYG) editor, which means that text being edited on the editor can look as similar as possible to the published results displayed to the users. The CKEditor can provide, on the web, common editing features found on desktop editing applications, such as Microsoft Word and OpenOffice.

The CKEditor can be used, in a compose user interface of a message box, as an email editor.

Message Handling:

A message handling engine can allow components to communicate with other internal components and with third party components. The message handling engine can work as an object relational mapping (ORM) layer between the application and the database. The message handling engine can provide seamless integration with exposed web services. All configurations of the message handling engine can be specified in an XML file. Message handling engine can provide further functionalities, such as SQL to Entity, SQL to List of Objects, SQL to XML, SQL to string, SQL to drop down list, Web service handler, and the like. Some of these functionalities are described below.

SQL to Entity: This functionality can help execute a SQL command, and transform the command to an entity. An entity can be a single row of a result set. The user can specify just the entity type that can be returned as a result of a query. The user can provide a hash table that has all the parameters, i.e. key value pairs. Key value pairs can be variable/value pairs that can be used in a query where clause. Key value pairs can be used to refine the query entity.

SQL to List of objects: This functionality can execute a SQL command, and can transform the SQL command to a List of Objects. The user can specify just the object type that can be returned as a result of query. The user can provide a hash table that has all the parameters i.e. key value pairs. Key value pairs can be variable/value pairs that can be used in a query where clause. Key value pairs can be used to refine the query entity.

SQL to XML: This functionality can help execute a SQL command and transform the SQL command to an XML string. The user can provide a hash table that has all the parameters i.e. key value pairs. Key value pairs can be variable/value pairs that can be used in a query where clause. Key value pairs can be used to refine the query entity.

SQL to String: This functionality can execute a SQL command and transform the SQL command to a string. The user can provide a hash table that has all the parameters i.e. key value pairs. Key value pairs can be variable/value pairs that can be used in a query where clause. Key value pairs can be used to refine the query entity.

SQL to Drop down List: This functionality can execute a SQL command and transform the SQL command to a drop down list object that can include the list of key value pairs. The user can provide the hash table that has all the parameters i.e. key value pairs.

Web service Handler: This functionality can call a web service. The user can just provide envelop that contains the message for the web service.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow, as depicted in the accompanying figures and described herein, does not require the particular order shown, or sequential order, to achieve desirable results. Other embodiments may be within the scope of the following claim.

1. A computer implemented method comprising:
crawling a plurality of heterogeneous vendor catalog web pages to download corresponding files characterizing the web pages, each catalog web page listing at least one product or service offered for sale;
scraping data from at least a portion of the downloaded files to generate a plurality of processed files and corresponding attributes characterizing each processed file;
indexing the attributes characterizing each processed file to the corresponding downloaded files in an index;
receiving search queries in a graphical user-interface;
polling the index to identify one or more of the downloaded files that correspond to the search queries; and
rendering, in the graphical user interface, data characterizing the identified one or more downloaded files.

2. A method as in claim 1, wherein the downloaded files are in Hyper-Text Markup Language (HTML) format.

3. A method as in claim 1, wherein the processed files are in eXtensible Markup Language (XML) format.

4. A method as in claim 1, wherein the processed files comprises attributes specified by a catalog data schema.

5. A method as in claim 1, further comprising:
storing user authentication data for the plurality of vendor catalog web pages, wherein at least two of the vendor web pages require different authentication data to complete a transaction for the corresponding product or service.

6. A method as in claim 5, wherein:
the rendered data characterizing the identified one or more downloaded files includes data from a first vendor web page requiring first user authentication data that is concurrently displayed in the graphical user interface with data from a second vendor page requiring second user authentication data;
the method further comprises:
receiving user-generated input, via the graphical user interface, selecting a graphical user interface element associated with the first vendor web page;
accessing the first vendor web page using the first user authentication data to purchase a corresponding product or service;
receiving user-generated input, via the graphical user interface, selecting a graphical user interface element associated with the second vendor web page; and
accessing the second vendor web page using the second user authentication data to purchase a corresponding product or service.

7. A method as in claim 1, wherein the polling is performed by a search engine.

8. A method as in claim 1, wherein the scraping parses the plurality of web pages to result in one or more attribute selected from a group consisting of: product item identifier, product description, long text, currency, price, unit, image, uniform resource locator (URL), and UNSPSC.

9. A non-transitory computer program product storing instructions, which when executed by at least one data processor of at least one computing system, result in operations comprising:
crawling a plurality of heterogeneous vendor catalog web pages to download corresponding files characterizing the web pages, each catalog web page listing at least one product or service offered for sale;
scraping data from at least a portion of the downloaded files to generate a plurality of processed files and corresponding attributes characterizing each processed file;
indexing the attributes characterizing each processed file to the corresponding downloaded files in an index;
receiving search queries in a graphical user-interface;
polling the index to identify one or more of the downloaded files that correspond to the search queries; and
rendering, in the graphical user interface, data characterizing the identified one or more downloaded files.

10. A computer program product as in claim 9, wherein the downloaded files are in Hyper-Text Markup Language (HTML) format.

11. A computer program product as in claim 9, wherein the processed files are in eXtensible Markup Language (XML) format.

12. A computer program product as in claim 9, wherein the processed files comprises attributes specified by a catalog data schema.

13. A computer program product as in claim 9, further comprising:
storing user authentication data for the plurality of vendor catalog web pages, wherein at least two of the vendor web pages require different authentication data to complete a transaction for the corresponding product or service.

14. A computer program product as in claim 13, wherein:
the rendered data characterizing the identified one or more downloaded files includes data from a first vendor web page requiring first user authentication data that is concurrently displayed in the graphical user interface with data from a second vendor page requiring second user authentication data;
the method further comprises:
receiving user-generated input, via the graphical user interface, selecting a graphical user interface element associated with the first vendor web page;
accessing the first vendor web page using the first user authentication data to purchase a corresponding product or service;
receiving user-generated input, via the graphical user interface, selecting a graphical user interface element associated with the second vendor web page; and
accessing the second vendor web page using the second user authentication data to purchase a corresponding product or service.

15. A computer program product as in claim 9, wherein the polling is performed by a search engine.

16. A computer program product as in claim 9, wherein the scraping parses the plurality of web pages to result in one or more attribute selected from a group consisting of: product item identifier, product description, long text, currency, price, unit, image, uniform resource locator (URL), and United Nations Standard Products and Services Code (UNSPSC).

17. A method comprising:
providing, in a unified catalog interface in response to a keyword search query, data characterizing products or services available from a plurality of vendors via respective websites that are responsive to the keyword search query, the respective websites requiring different user authentication information to purchase the corresponding products or services;
receiving, in the unified catalog interface, a selection of a graphical user interface corresponding to one or more of the products or services of each of two or more selected vendor websites;
accessing the websites corresponding to the selected graphical user interface element using stored corresponding user authentication information for each selected vendor website; and
automatically completing transactions to purchase each corresponding product or service from the two or more vendor websites.

18. A method as in claim 17, wherein each selected graphical user interface element causes the corresponding product or service to be placed in a single shopping cart of the unified interface, the single shopping cart allowing for a single checkout for products or services from different vendor websites requiring different user authentication.

19. A method as in claim 17, further comprising:
crawling a plurality of web pages for the plurality of vendors websites;
scraping the crawled plurality of web pages; and
generating an index linking the scraped web pages to the corresponding web pages for the vendor websites.

20. A method as in claim 17, wherein the scraping parses the plurality of web pages to result in one or more attribute selected from a group consisting of: product item identifier, product description, long text, currency, price, unit, image, uniform resource locator (URL), and United Nations Standard Products and Services Code (UNSPSC).
